(19) United States
(12) Patent Application Publication
(10) Pub. No.: US 2017/0114957 A1
(43) Pub. Date: Apr. 27, 2017

(54) LUBRICATION SYSTEM WITH LUBRICANT CONDITION MONITORING

(71) Applicant: Lincoln Industrial Corporation, St. Louis, MO (US)

(72) Inventors: Paul Conley, St. Charles, MO (US); James Morrow, St. Louis, MO (US); Nathan Donovan, Columbia, IL (US)

(21) Appl. No.: 15/304,660

(22) PCT Filed: Apr. 17, 2015
(86) PCT No.: PCT/US15/26469

§ 371 Date: Oct. 17, 2016

Related U.S. Application Data
(60) Provisional application No. 61/981,046, filed on Apr. 17, 2014.

(51) Int. Cl. F16N 29/02; F16N 19/00; F16N 7/38

(52) U.S. Cl. CPC F16N 29/02; F16N 7/38; F16N 19/00; F16N 2200/10; F16N 2250/08; F16N 2270/70; F16N 2280/00

(57) ABSTRACT

A lubrication system for lubricating at least one movable machine component includes a lubricant reservoir containing a lubricant and a fluid line fluidly coupled with the reservoir and having an outlet for dispensing the lubricant on or within the machine component. A valve selectively permits lubricant flow through the fluid line so as to dispense a quantity of lubricant through the fluid line outlet. A sensor senses a property of the machine component or the quantity of lubricant. A control is coupled with the sensor and with the valve, the control being configured to receive information from the sensor, to determine an estimated period of effectiveness of the quantity of lubricant using the sensor information, and to operate the valve based on the estimated lubricant effectiveness period so as to dispense another quantity of lubricant on or within the machine component.

### BACKGROUND OF THE INVENTION

The present invention relates to lubrication systems, and more particularly to lubrication systems with automatically-controlled valves.

Lubrication systems are known and typically contain a reservoir containing lubricant, one or more fluid supply lines for transporting the lubricant to a location to be lubricated, such as a machine component (e.g., a bearing) and a pump or other means to initiate flow from the reservoir, through the fluid lines and to the component to be lubricated. In certain systems, a valve controls flow from the supply line to the machine component and a controller is provided to operate the pump and open the valve(s). Typically, the controller will start the pump at a set time interval, open the one or more valves and then close the valves and stop the pump when all machine components have received re-lubrication.

Particularly when the lubricant is grease, the lubricant will degrade over time and become ineffective to prevent metal-to-metal contact between the lubricated components. Grease tends to lose consistency, such that oil in the grease bleeds out, and/or oxidizes and breaks down, so as to be generally incapable of providing a film thickness. Such degradation increases at elevated temperatures and higher speeds of the lubricated components, so as to decrease the effective “life” of the grease.

### SUMMARY OF THE INVENTION

In a first aspect, the present invention is a lubrication system for lubricating at least one movable machine component, the system comprising a lubricant reservoir containing a lubricant and a fluid line fluidly coupled with the reservoir and having an outlet for dispensing the lubricant on or within the machine component. A valve is configured to selectively permit lubricant flow through the fluid line so as to dispense a quantity of lubricant through the fluid line outlet. A sensor is configured to sense a property of one of the machine component and the quantity of lubricant. Further, a control is coupled with the sensor and with the valve, the control being configured to receive information from the sensor, to determine an estimated period of effectiveness of the quantity of lubricant using the sensor information, and to operate the valve based on the estimated lubricant effectiveness period so as to dispense another quantity of lubricant on or within the machine component.

In another aspect, the present invention is a lubrication system for lubricating first and second machine components. The lubrication system comprises a lubricant reservoir containing a lubricant, a first dispenser line fluidly coupled with the reservoir and having an outlet for dispensing lubricant on or within the first machine component, and a first dispenser valve for selectively permitting lubricant flow through the first dispenser line so as to dispense a first quantity of lubricant through the first fluid line outlet. A second dispenser line is fluidly coupled with the reservoir and has an outlet for dispensing lubricant on or within the second machine component, and a second dispenser valve selectively permits lubricant flow through the second dispenser line so as to dispense a second quantity of lubricant through the second fluid line outlet. Further, a control is coupled with each one the first and second valves, the control being configured to determine a first estimated period of effectiveness of the first quantity of lubricant, to determine a second estimated period of effectiveness of the second quantity of lubricant, to operate the first valve based on the first estimated lubricant effectiveness period so as to dispense another first quantity of lubricant on or within the first machine component, and to operate the second valve based on the second estimated lubricant effectiveness period so as to dispense another second quantity of lubricant on or within the second machine component. The second estimated lubricant effectiveness period is greater than the first estimated lubricant effectiveness period such that the control operates the first valve more frequently than the control operates the second valve.

In a further aspect, the present invention is a method of operating a lubrication system for lubricating a machine component, the lubrication system including a lubricant reservoir, a fluid line fluidly coupled with the reservoir and having an outlet for dispensing a quantity of lubricant on or within the machine component, a valve for selectively permitting lubricant flow through the fluid line, and a sensor for sensing a property of the machine component or the lubricant quantity. The method comprises the steps of: determining an estimated period of effectiveness of the quantity of lubricant using the sensor information, and operating the valve based on the estimated lubricant effectiveness period so as to dispense another quantity of lubricant on or within the machine component.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a more diagrammatic view of the lubrication system in accordance with the present invention;

FIG. 2 is a schematic view of a first construction of a lubrication system in accordance with the present invention;

FIG. 3 is a schematic view of a second construction of a lubrication system in accordance with the present invention;

FIG. 4 is a broken-away, enlarged view of a portion of FIG. 3;

FIG. 5 is an axial cross-sectional view of a bearing lubricated by the system;

FIG. 6 is a flow depicting a control operating a valve so as to dispense an entire predetermined quantity of grease in a single valve operation;

FIG. 7 is a flow diagram depicting a control operating a valve so as to dispense a predetermined quantity of grease in separate doses by multiple valve operations;

FIG. 8 is a perspective view of a plurality of a presently preferred type of valve each shown in combination with an injector and mounted to a manifold; and

FIG. 9 is a partly-broken away, cross-sectional view through one valve and injector shown in FIG. 8.

### DETAILED DESCRIPTION OF THE INVENTION

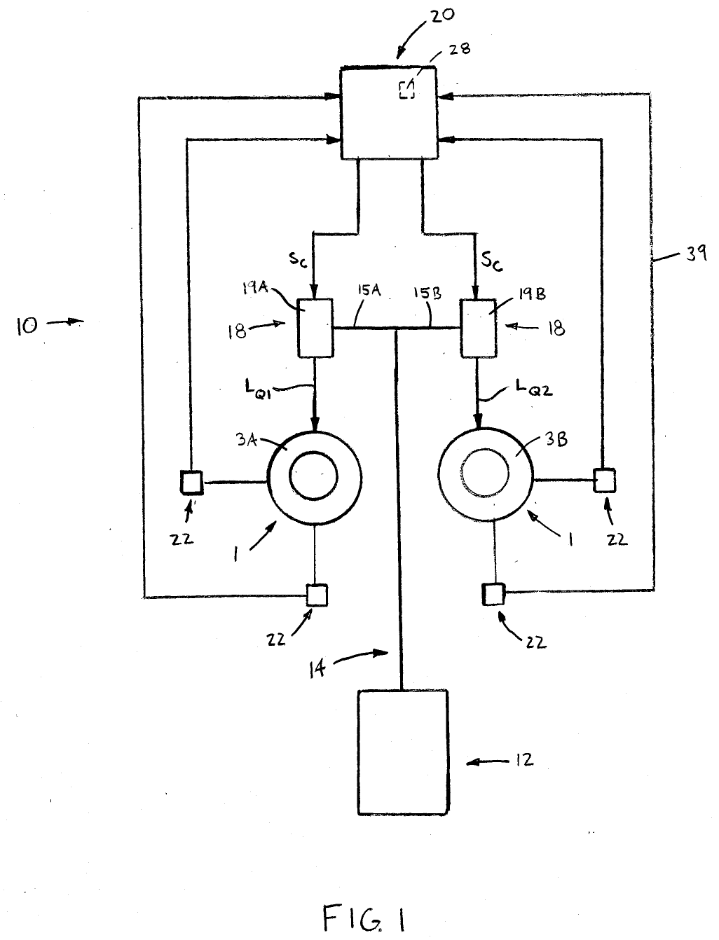

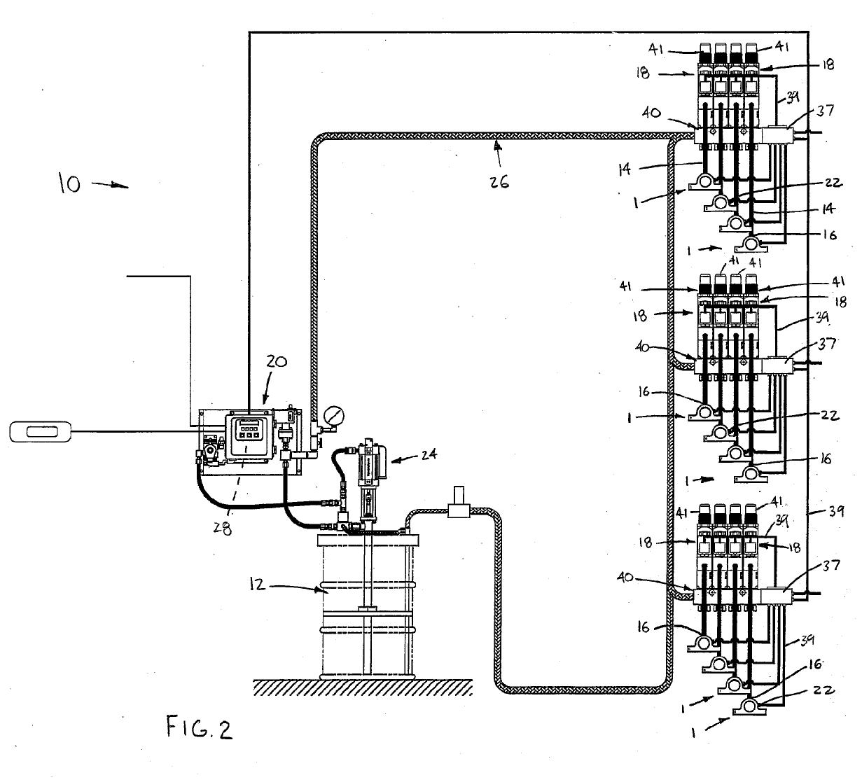

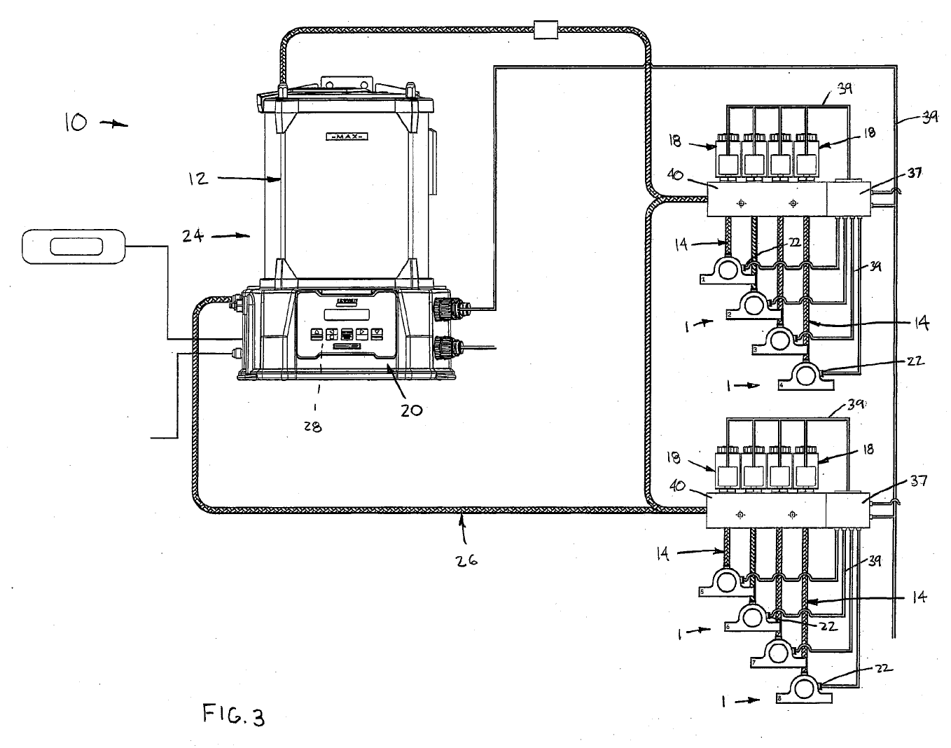

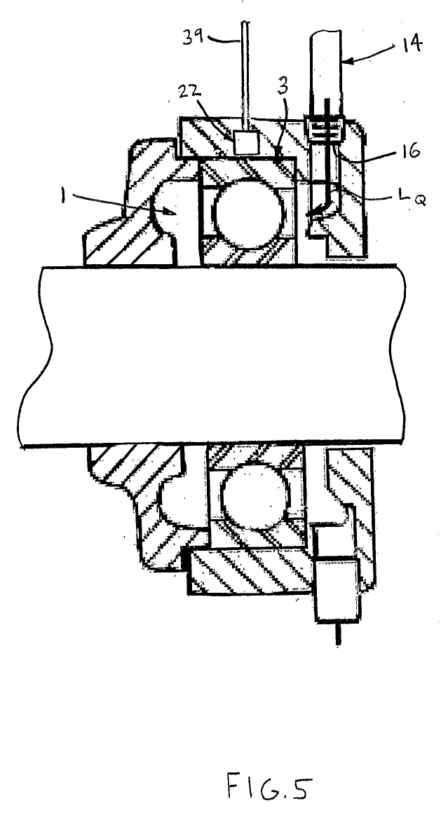

Referring now to the drawings in detail, wherein like numbers are used to indicate like elements throughout, there is shown in FIGS. 1-9 a lubrication system 10 for lubricating at least one and preferably a plurality of movable machine components 1, such as one or more bearings 2, with a lubricant, preferably grease. The lubrication system 10 basically comprises a lubricant reservoir 12, one or more fluid dispenser lines 14 fluidly coupled with the reservoir 12, one or more valves 18 each controlling flow through a separate one of the fluid lines 14, and a control 20 operatively coupled with each valve 18. The lubricant reservoir 12 may be a separate vessel or tank 11, as shown in FIG. 2, or may be integral with a pump 24 (described below), as shown in FIG. 3, in either case preferably containing a volume of grease. Each dispenser line 14 has an outlet 16 for dispensing a quantity of lubricant L_{Q} on or within the machine component 1 and each valve 18 selectively permits, and alternatively prevents, lubricant flow through the associated fluid line 14 so as to dispense a particular, “predetermined” quantity of the lubricant L_{Q}. The quantity of lubricant L_{Q} is predetermined to have a sufficient volume or amount to effectively lubricate each particular machine component 1, and therefore the actual volume/amount of each quantity of lubricant L_{Q} may vary between the different machine components 1 serviced by the system 10. That is, a larger machine component 1 (e.g., a first bearing) may require a greater quantity of lubricant L_{Q} than is necessary to lubricate a smaller machine component 1 (e.g., a second bearing), and vice-versa. Further, the control 20 is configured to operate each valve 18 so as to dispense a quantity of the lubricant L_{Q} on or within the associated machine component 1, to determine an estimated period of effectiveness of each lubricant quantity L_{Q}, and to operate each valve 18 based on the estimated lubricant effectiveness period P_{E} so as to dispense another lubricant quantity L_{Q} on or within each machine component 1. In other words, the control 20 operates the valves 18 to dispense more or “fresh” lubricant on or within each associated machine component 1 when, and preferably before, the particular quantity of lubricant L_{Q} lubricating the component 1 has reached the limit of effectiveness or lubricant “life”.

As used herein, the terms “period of effectiveness P_{E}” and “lubricant effectiveness period P_{E}” each mean a period of time during which a particular quantity of lubricant L_{Q} remains at least generally capable of effectively lubricating a particular machine component 1. In other words, the “period of effectiveness P_{E}” and “lubricant effectiveness period P_{E}” each mean an estimated time interval from the point in time at which a “fresh” quantity of lubricant L_{Q} has been dispensed into or onto a machine component 1 to a point in time at which the particular lubricant quantity L_{Q} will have degraded to the extent of becoming generally ineffective to lubricate the machine component 1. As discussed below, the period of effectiveness P_{E} is determined from empirical data and varies due to structural characteristics of the machine component 1 being lubricated, the material properties (e.g., rheological, chemical, etc.) of the particular lubricant, and the particular operating conditions (e.g., temperature, speed, etc.) of the machinery component 1 and/or the lubricant quantity L_{Q}. Also as used herein, the words “connected” and “coupled” are each intended to include direct connections between two members without any other members interposed therebetween, indirect connections between members in which one or more other members are interposed therebetween, and operative connections without any direct or indirect physical connections between the two members

Preferably, the lubrication system 10 further comprises one or more sensors 22 each coupled with the control 20 and each configured to sense a speed of an associated one of the first machine components 1 (e.g., shaft speed, bearing rotational speed, etc.), a temperature of the associated machine component 1, or a temperature of the lubricant quantity L_{Q} on or within the associated machine component 1. The system 10 may include two or more sensors 22 for sensing different properties of each particular machine component 1 or/and the quantity of lubricant L_{Q} on or within the component 1, such as for example, one sensor 22 for sensing machine component speed and another sensing temperature of the lubricant quantity L_{Q} on/within that component 1, etc.

With such sensors 22, the lubrication control 20 is configured to receive information from each one of the sensors 22 and to determine the estimated period of effectiveness P_{E} of the each lubricant quantity L_{Q} using information from the associated sensor 22 (i.e., the particular sensor 22 monitoring the specific component 1 or lubricant quantity L_{Q} on or within the component 1). The sensors 22 provide information considered to affect lubrication effective life and may also include sensors 22 for sensing other properties or operating conditions of the machine component 1 or lubricant quantity L_{Q}, such as lubricant pressure within the component 1, lubrication volume, or any other relevant property/condition. Further, the control 20 preferably also uses constant or non-variable information to determine or calculate lubricant effectiveness period P_{E}, such as total available space or volume for the lubricant, fixed loading on a machine component 1, rheological properties of the lubricant, etc.

Most preferably, the control 20 is configured to determine or calculate the lubricant effectiveness period P_{E} using both information from the sensors 22 and empirically-derived data stored within memory of the control 20. Such data may be generated by measuring the time period between the point in time at which a quantity of “fresh” (i.e., unused) lubricant is applied or injected into/on a particular machine component 1 until the point at which the particular quantity of lubricant has degraded to the extent of being generally ineffective to lubricate, or at least the lubrication effectiveness has diminished significantly. Preferably, the data is generated for each one of a plurality of different sets or combinations of operating conditions, such as different temperatures of the machine component 1 and/or lubricant quantity, different machine operating speeds, and for any other relevant variable operating condition or parameter. Using such empirically-derived data stored within electronic memory, the control 20 is configured (i.e., by means of stored software, wiring, etc.) to determine the lubricant effectiveness period P_{E} based upon information from the sensor(s) 12 at the time the quantity of lubricant L_{Q} is applied or injected into/on the machine component 1. However, the lubricant effectiveness period P_{E} may be determined by any other appropriate means.

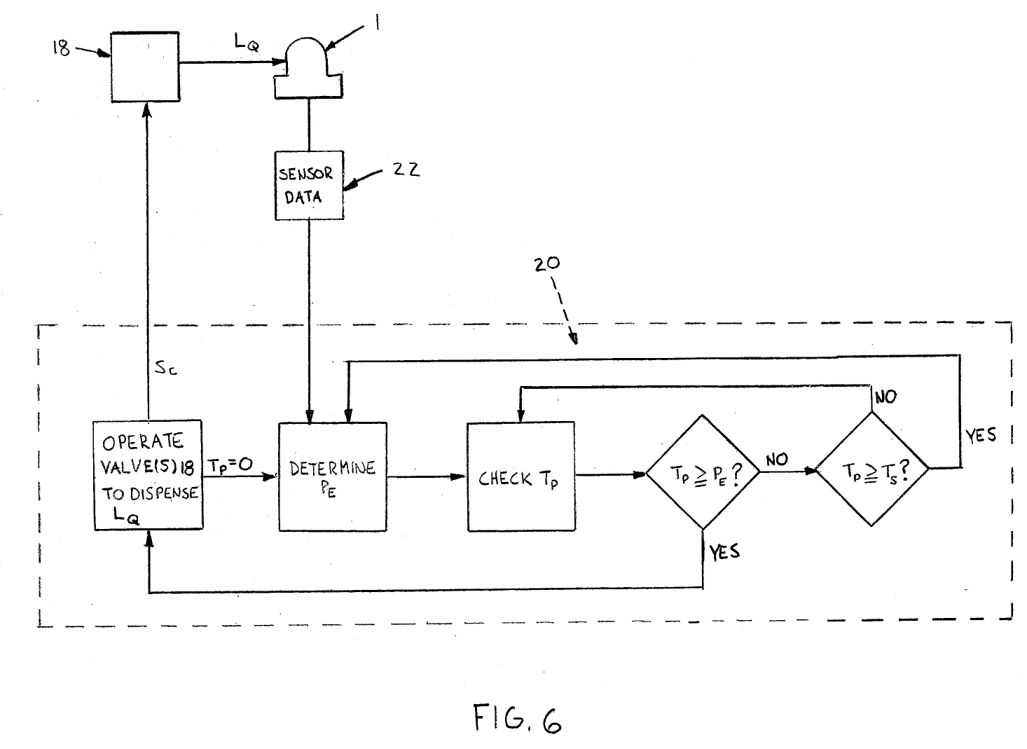

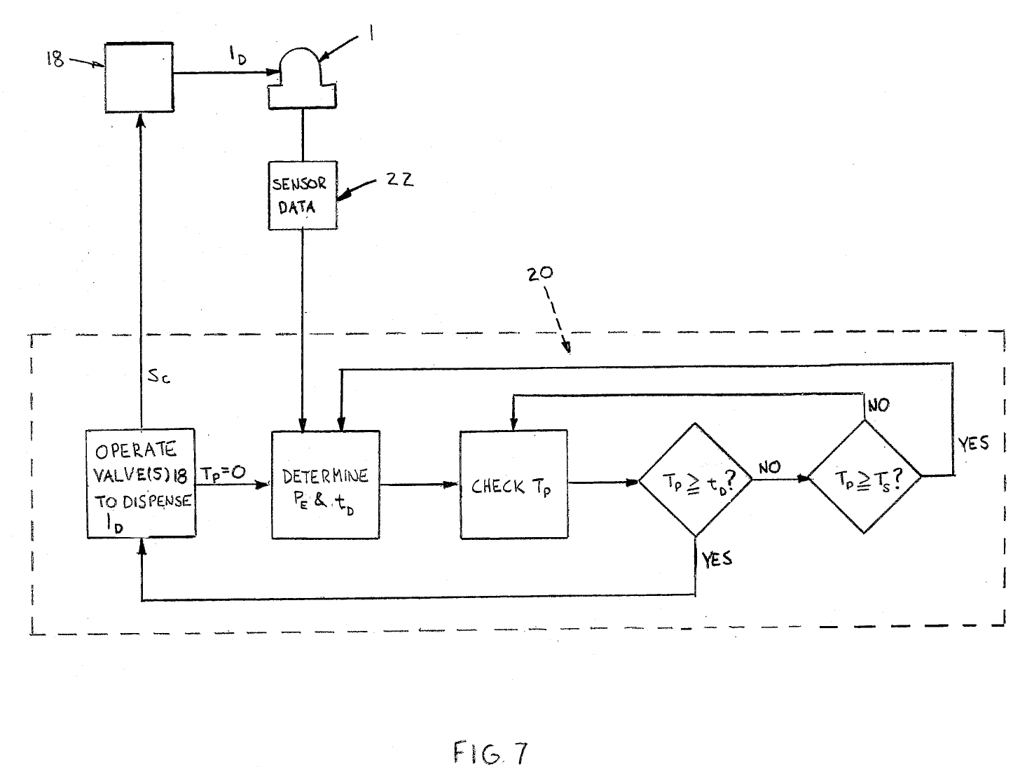

Further, the control 20 is preferably also configured to recalculate the estimated lubricant effectiveness period P_{E} after each lapse of a sampling time period P_{S} and to adjust the value of the estimated lubricant effectiveness period P_{E} when sensor information varies during the sampling period P_{S}. For example, if a sensor 22 determines that the speed (e.g., rotational) of the machine component 1 increases, or/and the temperature of the component 1 or/and lubricant quantity L_{Q} increases, during the sampling period P_{S}, the control 20 will reduce the lubricant effectiveness period P_{E}, and vice-versa. More specifically, the control 20 is preferably configured to continuously track or record a time period T_{P} after each operation (e.g., opening and closing) of each valve 18 and to compare the time period T_{P} to a value of the estimated lubrication effectiveness period P_{E}, as indicated in FIGS. 6 and 7. Further, the control 20 operates each valve 18, preferably by means of a control signal S_{C}, when the time period T_{P} is either at about the value of the estimated lubricant effectiveness period P_{E} or at about a predetermined portion (e.g., ninety-five percent (95%), fifty percent (50%)) of the value of the estimated lubricant effectiveness period P_{E}. As such, replenishment or dispensing of another quantity of lubricant L_{Q} to replace each particular quantity of lubricant L_{Q} in or on the machine component 1 is initiated either when or before the lubricant begins to lose effectiveness.

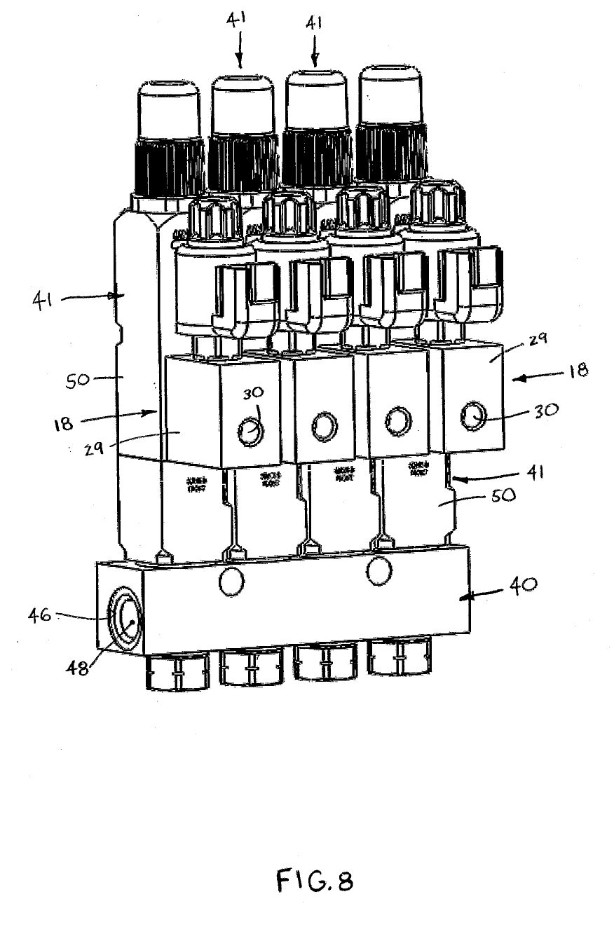

Furthermore, lubrication may be dispensed either in a single operation of each dispenser valve 18 (i.e., valve remains open until the entire lubricant quantity L_{Q} flows onto or within the machine component) or in multiple valve operations. Specifically, the control 20 can be configured to operate each valve 18 such that the valve 18 is opened and remains open to dispense an amount of lubricant of about the desired quantity of lubricant L_{Q} in a single operation (i.e., when T_{P}<=P_{E}), as indicated in FIG. 7. Alternatively, the control 20 may be configured to operate one or more (or all) of the valves 18 such that each valve 18 dispenses two or more lubricant doses l_{D} at two or more dosing time intervals t_{D} during the estimated lubricant effectiveness period P_{E}, the total amount or volume of the two or more lubricant doses l_{D} being approximately equal to the quantity of lubricant L_{Q}, as depicted in FIG. 8. When the control 20 is configured to operate a valve 18 so as to dispense lubricant doses l_{D}, the control 20 determines the lubricant effectiveness period P_{E} for the total quantity of lubricant L_{Q} on/within machine component 1 being lubricated by the valve 18, then determines the dosing time intervals t_{D} as a portion of the total lubricant effectiveness period P_{E} and the lubricant dose l_{D} as a corresponding portion of the total quantity of lubricant L_{Q}. For example, the control 20 may operate each valve 18 to deliver two doses l_{D} each equal to half the total lubricant quantity L_{Q}, one when the time period T_{P} is at approximately half of the estimated lubricant effectives period P_{E} (i.e., t_{D}≈½P_{E}) and the other when the time period T_{P} is at about (or just prior to) the total estimated lubricant effectiveness period P_{E}.

Referring to FIGS. 2 and 3, the lubrication system 10 further comprises a pump 24 fluidly coupled with the lubricant reservoir 12 and with the dispenser lines 14, preferably through a supply line 26 that fluidly couples the reservoir 12 and each separate fluid line 14. As such, the pump 24 directs flow from the reservoir 12 through the supply line 26 and to each dispenser line 14. The control 20 is configured to operate the pump 24 such that a pressure of lubricant within the supply line 26 and the individual dispenser lines 14 has at least a predetermined value when the control 20 operates one or more selected valves 18. That is, the pump 18 should pressurize the lubricant to the desired level, prior to opening one or more of the valves 18, such that lubricant will flow through the dispenser lines 14 and through the dispenser line outlet 16 at a desired flow rate. Thus, the control 20 is configured to start the pump 24 prior to opening one or more valves 18 and to stop the pump 24 after closing the valve(s) 18, such that the control 20 does not operate the pump 24 when no lubricant is being dispensed.

Preferably, the control 20 includes an electronic controller 28 having electronic memory with stored software for operating the one or more valves 18 and the pump 24. Specifically, the controller software preferably calculates the lubrication effectiveness periods and performs all control functions described above or discussed below, such as opening and closing the valves 18, operating the pump 24, etc. Preferably, the memory of the control 20 also includes stored information concerning each particular machine component 1, such as volume to be lubricated, dimensions of and loading conditions on the component 1, properties of the specific type of lubricant (preferably a type of grease), such as rheological properties of the lubricant, empirically derived lubricant effectiveness periods P_{E} for various conditions, and any other information that the control 20 utilizes to determine or calculate lubricant effectiveness period P_{E}, as discussed above. Further, the control 20 is preferably either a separate master controller or a controller integral with the pump 24. Although preferably being a digital electronic controller with stored software, the control 20 may alternatively be an analog electronic controller or any other appropriate type of control.

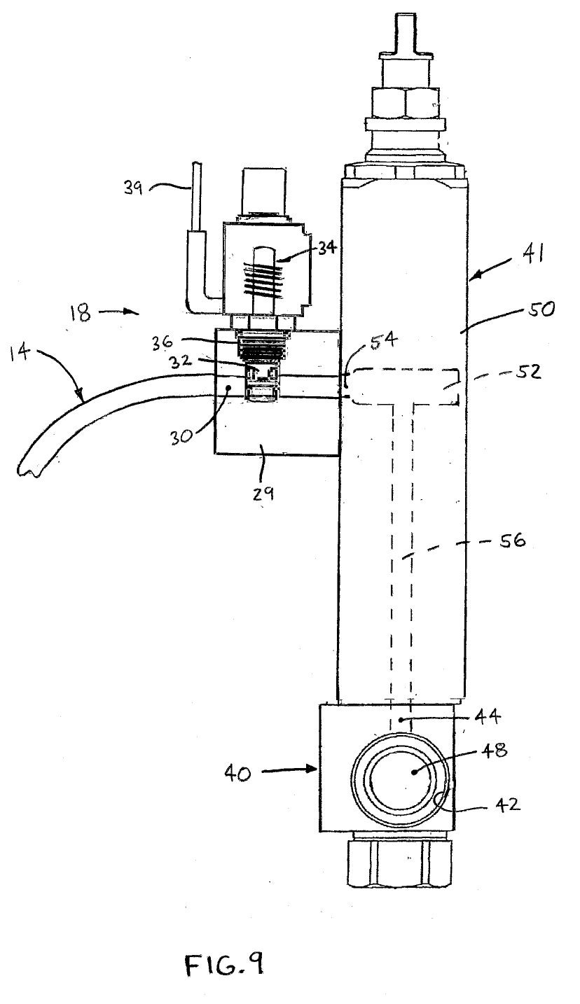

Referring particularly to FIG. 9, each valve 18 preferably includes a valve body 29 with an internal passage 30 and a closure element 32. The valve passage 30 fluidly couples the lubricant reservoir 12 (i.e., through the supply line 26 and a manifold 40 and an injector 41, described below) with the dispenser line outlet 16 of the associated dispenser line 14. The closure element 32 is movable between a closed position, at which lubricant flow through the valve passage 30 is obstructed, and an open position at which lubricant flow through the valve passage 30 is permitted. Each valve 18 preferably further includes a solenoid 34 for displacing the closure element 32 between the closed and open positions to obstruct and permit lubricant flow, and biasing member 36 such as a spring to return the closure element 34 to the closed position. With valves 18 each having a solenoid 34, the control 20 is electrically connected with each solenoid 34, preferably through a relay 35 and a bus line 39 (described below), and is configured to initiate displacement of the closure element 32 from the closed position to the open position, preferably by means of a control signal S_{C}. Most preferably, each valve 18 is a commercially available, normally-open poppet valve, such as for example, from HydraForce, Inc. of Lincolnshire, Ill., but may be any other appropriate type of valve capable of functioning as generally described herein.

Referring now to FIGS. 2, 8 and 9, in certain constructions, the lubrication system 10 further includes at least one manifold 40 and at least one and preferably a plurality of injectors 41 each fluidly coupling a separate valve 18 with one manifold 40. Each manifold 40 has an inlet port 42 connected with the supply line 26, at least one and preferably a plurality of dispenser ports 44 each connected with a separate one of the injectors 41, and a return port 46 fluidly connected with the supply line 26 or/and the reservoir 12. An internal passage 48 of each manifold 40 fluidly connects the inlet port 42, the dispenser ports 44 and the return port 46. As best shown in FIGS. 8 and 9, each injector 41 has an elongated body 50 mounted to one manifold 40 and to which one valve 18 is mountable, an internal measuring chamber 52 configured to provide the predetermined fluid quantity of lubricant L_{Q} or lubricant dose l_{D}, and an outlet port 54 fluidly coupling the measuring chamber 52 with the passage 30 of the associated valve 18. Each injector 41 further has one or more fluid passages 56 (only one shown) fluidly coupling an associated one of the manifold dispenser ports 44 with the measuring chamber 52 and one or more movable closure elements (none shown) for controlling lubricant flow through the passage(s) 56 and into the measuring chamber 52.

The volume of the lubricant within the measuring chamber 52 is adjustably variable to provide a specific, predetermined quantity of lubricant L_{Q} or a specific, predetermined lubricant dose l_{D} through the associated valve 18. Although a detailed description of each injector 41 is beyond the scope of the present disclosure, each injector 41 and the one or more manifolds 40 are preferably formed as generally disclosed in U.S. Pat. Nos. 6,705,432 and 6,810,998, the entire contents of each being incorporated by reference herein. However, the valves 18, the manifold(s) 40 and/or the injectors 41 may be formed in any other appropriate manner, such as for example, as separate valves 18 without any manifold or injector, as valves, manifolds and/or injectors having structures differing from those disclosed in two cited patents, etc. Further, the valves 18 themselves may be constructed or configured to provide a predetermined quantity or amount of lubricant, the quantity/amount being adjustable for differing lubrication requirements, such that the lubrication system 10 may be formed without any injectors. Thus, the scope of the present invention is in no manner limited to any particular structure of the one or more valves 18 or the associated fluid components.

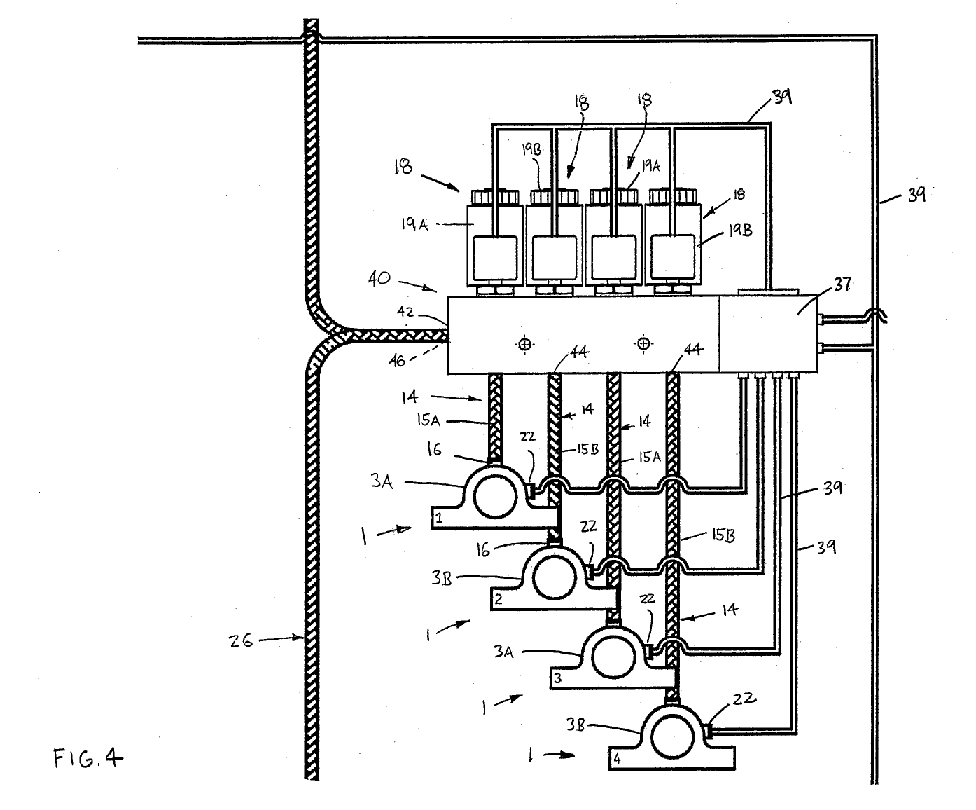

Referring now to FIGS. 3 and 4, in other constructions, the lubrication system 10 does not include any injectors, such that each valve 18 is preferably directly mounted to a manifold 40. In such a lubrication system 10, the pump 24 is preferably configured to deliver or dispense a predetermined quantity of lubricant L_{Q} through each valve 18 when the particular valve 18 is opened, so thereby deliver the lubricant quantity L_{Q} to the associated machine component 1. Preferably, the pump 24 is capable of delivering different, specified amounts of lubricant to each valve 18, dependent on the requirements for lubricating the particular machine component 1 associated with the valve 18, with the specific amounts of lubricant being adjustable. In such constructions, the pump 24 is preferably constructed or formed as generally described in U.S. Pat. Nos. 8,844,679 and 9,022,177, the entire contents of each patent being hereby incorporated by reference herein. However, the pump 24 may be constructed/formed in any other appropriate manner that provides the capability of delivering or dispensing a predetermined amount or quantity of lubricant through each valve 18.

Referring to FIGS. 2-4, the lubrication system 10 preferably further includes one or more relays 37 electrically connected with the control 20 and one or more bus lines 39 electrically connecting each valve solenoid 34 and each sensor 22 to one of the relays 37 or connecting the relay(s) 37 to the control 20. Thereby, the sensors 22 transmit information (temperature, speed, pressure) from each machine component 1 to the associated relay 37, which is then transmitted electrically to the control 20, and the control 20 transmits commands, preferably as a control signal S_{C}, to the solenoid 34 of each valve 18 through the relays 37.

Referring particularly to FIGS. 1 and 4, certain primary benefits of the lubrication system 10 are most easily discerned when considering a system 10 for lubricating at least two machine components 1 (e.g., bearings) operating under substantially different conditions, such as different load, speed or temperature conditions. For example, a lubrication system 10 for lubricating a first machine component 3A and a second machine component 3B, which may bearings, gears, etc., includes first and second dispenser lines 15A, 15B each fluidly coupled with the reservoir 12, preferably through the supply line 26. The first dispenser line 15A has an outlet 16 for dispensing a first quantity of lubricant L_{Q1} on or within the first machine component 3A and the second dispenser line 15A has an outlet 16 for dispensing a second quantity of lubricant L_{Q2} on or within the second machine component 3A. A first dispenser valve 19A selectively permits lubricant flow through the first dispenser line 15A to dispense the first, predetermined quantity of lubricant L_{Q1} and a second dispenser valve 19B selectively permits lubricant flow through the second dispenser line 15B to dispense the second, predetermined quantity of lubricant L_{Q2}.

The control 20 is coupled with each one the first and second valves 19A, 19B and is configured to determine a first estimated period of effectiveness P_{E1} of the first quantity of lubricant L_{Q1} and to determine a second estimated period of effectiveness P_{E2} of the second quantity of lubricant L_{Q2}. The control 20 is also configured to operate the first dispenser valve 19A based on the first estimated lubricant effectiveness period P_{E1} so as to dispense another first quantity of lubricant L_{Q1} on or within the first machine component 3A and to operate the second dispenser valve 19B based on the second estimated lubricant effectiveness period P_{E2} so as to dispense another second quantity of lubricant L_{Q2} on or within the second machine component 3B. When the second estimated lubricant effectiveness period P_{E2} is greater than the first estimated period of effectiveness P_{E1}, the control 20 operates the first valve 19A more frequently than the control 20 operates the second valve 19B, and vice-versa.

Thus, the control 20 will operate each valve 19A, 19B independently of the other valve 19B, 19A, such that only the machine component 3A, 3B requiring lubrication due to a particular quantity of lubricant L_{Q1}, L_{Q2} reaching the end of its effective life. That is, the control 20 is configured to separately operate the first valve 19A, such that the first valve 19A opens while the second valve 19B remains closed, and to alternatively operate the second valve 19B, such that the second valve 19B opens while the second valve 19A remains closed. However, the control 20 may operate both the first and second valves 19A, 19B, respectively, at the same time, such that both valves 19A, 19B are open at the same time, but only at instances when both the first and second lubricant quantities L_{Q1}, L_{Q2} of require replenishment or replacement.

Although the above-described example describes only first and second valves 19A, 19B controlling lubrication to first and second machine components 3A, 3B, the present lubrication system 10 may be used with any number of valves 18 and dispenser lines 14 for lubricating a like number of machine components 1.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined herein and in the appended claims.

We claim:

1. A lubrication system for lubricating at least one movable machine component, the system comprising;
a lubricant reservoir containing a lubricant;
a fluid line fluidly coupled with the reservoir and having an outlet for dispensing the lubricant on or within the machine component;
a valve for selectively permitting lubricant flow through the fluid line so as to dispense a quantity of lubricant through the fluid line outlet;
a sensor for sensing a property of one of the machine component and the quantity of lubricant; and
a control coupled with the sensor and with the valve, the control being configured to receive information from the sensor, to determine an estimated period of effectiveness of the quantity of lubricant using the sensor information, and to operate the valve based on the estimated lubricant effectiveness period so as to dispense another quantity of lubricant on or within the machine component.

2. The lubrication system as recited in claim 1 wherein the control includes an electronic controller having memory with stored software for operating the valve.

3. The lubrication system as recited in claim 1 wherein the control is configured to recalculate the estimated lubricant effectiveness period after each lapse of a sampling time period and to adjust the value of the estimated lubricant effectiveness period when sensor information varies during the sampling period.

4. The lubrication system as recited in claim 1 wherein the control is configured to track a time period after each operation of the valve, to compare the time period to a value of the estimated lubrication effectiveness period, and to operate the valve when the time period is one of at about the value of the estimated lubricant effectiveness period and at about a predetermined portion of the value of the estimated lubricant effectiveness period.

5. The lubrication system as recited in claim 4 wherein the control is configured to operate the valve such that:
the valve dispenses an amount of lubricant of about the quantity of lubricant;
the valve dispenses two or more lubricant doses at two or more time intervals during the estimated lubricant effectiveness period, the total amount of the two or more lubricant doses being approximately equal to the quantity of lubricant.

6. The lubrication system as recited in claim 1 wherein the sensor is configured to sense one of a speed of the machine component, a temperature of the machine component and a temperature of the quantity of lubricant.

7. The lubrication system as recited in claim 1 further comprising a pump fluidly coupled with the lubricant reservoir and with the fluid line, the control being configured to operate the pump such that a pressure of lubricant within fluid line has at least a predetermined value when the control operates the valve.

8. The lubrication system as recited in claim 7 wherein the control includes an electronic controller having memory with stored software for operating the valve and the pump.

9. The lubrication system as recited in claim 7 wherein the control is configured to start the pump prior to opening the valve and to stop the pump after closing the valve.

10. The lubrication system as recited in claim 1 wherein the valve includes a passage fluidly coupling the lubricant reservoir with the fluid line outlet, a closure element movable between a closed position at which lubricant flow through the valve passage is obstructed and an open position at which lubricant flow through the valve passage is permitted, and a solenoid for displacing the closure element between the closed and open positions, the control being electrically connected with the solenoid and configured to initiate displacement of the closure element from the closed position to the open position.

11. The lubrication system as recited in claim 1 wherein the fluid line includes a plurality of fluid line sections each having an outlet for dispensing lubricant at or within a separate one of plurality of machine components, the valve includes a plurality of the valves each connected with a separate one of the fluid line sections, and the sensor includes a plurality of the sensors each configured to sense at least one of a speed of a separate one of the machine components, a temperature of a separate one of the machine components and a temperature of a quantity of lubricant on or within a separate one of the machine components.

12. The lubrication system as recited in claim 1 wherein one of:
the lubrication system further comprises an injector configured to provide a predetermined quantity of lubricant through the valve; and
the pump is configured to deliver a predetermined quantity of lubricant through the valve.

13. A lubrication system for lubricating first and second machine components, the lubrication system comprising:
a lubricant reservoir containing a lubricant;
a first dispenser line fluidly coupled with the reservoir and having an outlet for dispensing lubricant on or within the first machine component;
a first dispenser valve for selectively permitting lubricant flow through the first dispenser line so as to dispense a first quantity of lubricant through the first fluid line outlet;
a second dispenser line fluidly coupled with the reservoir and having an outlet for dispensing lubricant on or within the second machine component;
a second dispenser valve for selectively permitting lubricant flow through the second dispenser line so as to dispense a second quantity of lubricant through the second fluid line outlet; and
a control coupled with each one the first and second valves, the control being configured to determine a first estimated period of effectiveness of the first quantity of lubricant, to determine a second estimated period of effectiveness of the second quantity of lubricant, to operate the first valve based on the first estimated lubricant effectiveness period so as to dispense another first quantity of lubricant on or within the first machine component, and to operate the second valve based on the second estimated lubricant effectiveness period so as to dispense another second quantity of lubricant on or within the second machine component, the second estimated lubricant effectiveness being greater than the first estimated period of effectiveness such that the control operates the first valve more frequently than the control operates the second valve.

14. The lubrication system as recited in claim 13 wherein the control is configured to operate the first valve such that the first valve opens while the second valve remains closed and to alternatively open the second valve such that the second valve opens while the first valve remains closed.

15. The lubrication system as recited in claim 13 further comprising:
a first sensor coupled with the control and configured to sense one of a speed of the first machine component, a temperature of the first machine component and a temperature of the first quantity of lubricant; and
a second sensor coupled with the control and configured to sense one of a speed of the first machine component, a temperature of the first machine component and a temperature of the first quantity of lubricant; and
wherein the control is configured to receive information from each one of the first and second sensors, to determine the estimated period of effectiveness of the first lubricant quantity using information from the first sensor and to determine the estimated period of effectiveness of the second quantity of lubrication using information from the second sensor.

16. The lubrication system as recited in claim 13 wherein the control includes an electronic controller having memory with stored software for operating each one of the first and second valves.

17. The lubrication system as recited in claim 13 wherein the control is configured to:
recalculate the first lubricant quantity estimated effectiveness period after each lapse of a sampling time period and to adjust the value of the first lubricant quantity estimated lubricant effectiveness period when first sensor information varies during the sampling period; and
recalculate the second lubricant quantity estimated effectiveness period after each lapse of a sampling time period and to adjust the value of the second lubricant quantity estimated lubricant effectiveness period when second sensor information varies during the sampling period.

18. The lubrication system as recited in claim 13 wherein the control is configured to:
track a first time period after each operation of the first valve, to compare the first time period to a value of the first lubricant quantity estimated effectiveness period, and to operate the first valve when the time period is one of at about the value of the first lubricant quantity estimated effectiveness period and at about a predetermined portion of the value of the first lubricant quantity estimated effectiveness period; and
track a second time period after each operation of the second valve, to compare the second time period to a value of the second lubricant quantity estimated effectiveness period, and to operate the second valve when the time period is one of at about the value of the second lubricant quantity estimated effectiveness period and at about a predetermined portion of the value of the second lubricant quantity estimated effectiveness period.

19. The lubrication system as recited in claim 18 wherein the control is configured to operate each one of the first and second valves such that one of:
the first valve dispenses an amount of lubricant of about the first quantity of lubricant and the second valve dispenses a an amount of lubricant of about the second quantity of lubricant; and
the first valve dispenses two or more lubricant doses at two or more time intervals during the estimated lubricant effectiveness period, the total amount of the two or more lubricant doses being approximately equal to the first quantity of lubricant and the second valve dispenses two or more lubricant doses at two or more time intervals during the second lubricant quantity estimated effectiveness period, the total amount of the two or more lubricant doses being approximately equal to the second quantity of lubricant.

20. The lubrication system as recited in claim 13 further comprising a pump fluidly coupled with the lubricant reservoir and with each one of the first and second fluid lines, the control being configured to operate the pump such that a pressure of lubricant within each fluid line has at least a predetermined value when the control operates each one of the first and second valves.

21. A method of operating a lubrication system for lubricating a machine component, the lubrication system including a lubricant reservoir, a fluid line fluidly coupled with the reservoir and having an outlet for dispensing a quantity of lubricant on or within the machine component, a valve for selectively permitting lubricant flow through the fluid line, a sensor for sensing a property of the machine component or the lubricant quantity, the method comprising the steps of:
determining an estimated period of effectiveness of the quantity of lubricant using the sensor information; and
operating the valve based on the estimated lubricant effectiveness period so as to dispense another quantity of lubricant on or within the machine component.

22. The method of operating a lubrication system as recited in claim 21 wherein the system includes a control coupled with the sensor and the valve, the control performing the steps of determining the estimated lubricant effectiveness period and operating the valve.
